(19) United States
(12) Patent Application Publication
(10) Pub. No.: US 2026/0231929 A1
(43) Pub. Date: Aug. 13, 2026

(54) SOLVENT COMPOSITION FOR AGROCHEMICAL FORMULATIONS

(71) Applicant: SPECIALTY OPERATIONS FRANCE, Lyon (FR)

(72) Inventors: Rawad Tadmouri, Pessac Cedex (FR); Valentin Goussard, Aubervillers Cedex (FR); Monique Adamy, Asnieres Sur Seine (FR)

(73) Assignee: SPECIALTY OPERATIONS FRANCE, Lyon (FR)

(21) Appl. No.: 19/155,317

(22) PCT Filed: Feb. 8, 2024
(86) PCT No.: PCT/EP2024/053195

§ 371 Date: Aug. 11, 2025

(30) Foreign Application Priority Data
Feb. 9, 2023 (EP) 23305181.2

(51) Int. Cl. A01N 25/02; A01N 43/54; A01N 43/653

(52) U.S. Cl. CPC A01N 25/02; A01N 43/54; A01N 43/653

(57) ABSTRACT

A composition includes at least one first solvent of general formula (A); and at least one second solvent of a general formula (D). General formulae (A) and (D) are as shown below. In general formula (A), R represents a linear or branched alkyl group. In general formula (D), R″ is a linear or branched (C₃-C₁₉)alkyl group, and R₂ and R₃, which are identical or different, denote a hydrogen atom or a (C₁-C₆)alkyl, with the proviso that if R₂ is a hydrogen atom, then R₃ is a (C₁-C₆)alkyl.

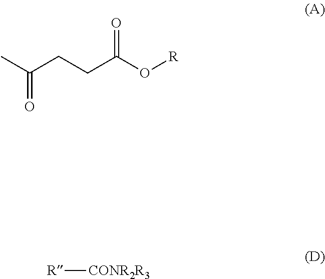

The present invention relates to a solvent composition comprising at least one particular levulinate ester as first solvent and at least one particular amide as second solvent.

The invention also relates to the use of the solvent composition for preparing an agrochemical formulation and to the agrochemical formulation itself.

Agriculture uses many agricultural materials such as fertilisers or pesticides, for example insecticides, herbicides or fungicides. They are also referred to as active plant-protection products or active materials or active substances. Agricultural materials are generally products in pure or highly concentrated form.

In general, agricultural materials are not employed as pure substances, but depending on the field of application and the desired physical constituency of the use form, they are generally formulated with other ingredients.

Independently of the type of formulation and of whether the formulation comprises one or more agricultural materials, one attempts, in particular in the field of agriculture, to achieve as high an agricultural material concentration as possible of the respective formulation since a high concentration of the agricultural materials allows the volumes to be applied to be reduced and, as a consequence, entails savings with regard to the adjuvant materials applied and with regard to packaging and logistics. Highly-concentrated stable formulations and coformulations with environmentally friendly adjuvants are therefore of interest as a matter of principle.

Frequently, such formulations comprise combinations of different agricultural materials instead of individual agricultural materials in order to jointly utilize the properties of the individual agricultural materials upon application, or else because the individual agricultural materials are synergistic in combination, i.e. produce superadditive increases in activity.

In the application of products for agricultural use, it is widely known to combine two or more agricultural materials having a different mechanism of action and/or different biological target, to broaden the action range of the mixture with respect to ones of the agricultural materials used individually and for example to prevent the occurrence of resistance phenomena from the harmful organisms or species, phenomena which over time tend to reduce the effectiveness of the pesticide products used.

Depending on the respective physico-chemical characteristics of the various agricultural materials and their loading in the targeted formulation, it can be very challenging to identify suitable co-formulants to obtain a chemically and physically stable formulation.

For agricultural materials with a low or relatively low water solubility, the use of appropriate solvents is especially interesting to prepare concentrated liquid formulations, in the form of emulsifiable concentrates (EC), concentrated emulsions in water (EW), microemulsions (ME), suspoemulsions (SE), oil dispersions (OD), dispersible concentrates (DC). More details on the definitions of above-mentioned formulations can be found in the “Guidance document for the generation of data on the physical, chemical and technical properties of plant protection products under regulation (EC) N^{o} 1107/2009 of the EU parliament and council on placing plant protection products on the market”.

Such concentrated formulations of agricultural materials are generally diluted prior to agricultural use. The dilution effected by the farmer is generally performed by mixing the agrochemical formulation with water.

Depending on the characteristics of the concentrated formulation, the diluted formulation may be in the form of a solution, an emulsion, a suspension, or a suspo-emulsion.

Furthermore, the agrochemical formulations generally comprise compounds that enable these physical forms to be obtained. They may be, for example, surfactants, polymers, solvents, mineral supports and/or dispersants. Quite often, these compounds do not have any active nature, but intermediary nature that aids formulation. It is thus often desired to limit their amounts in order to limit the costs and/or any harm to the environment.

In addition, certain solid agricultural materials are often difficult to formulate. For certain agricultural materials, it is difficult to produce concentrated formulations that are easy for the farmer to dilute, stable and free of substantial drawbacks (real or perceived) with regard to safety, toxicity and/or ecotoxicity. For certain agricultural materials, it is difficult to formulate at relatively high concentrations with sufficient stability. In particular, it is necessary to avoid the appearance of crystals, in particular at low temperature and/or during dilution and/or during storage of the dilute composition, in particular at low temperature. The crystals may have harmful effects, especially blocking the filters of the devices used for spreading the dilute composition, blocking the spraying devices, reducing the overall activity of the formulation, creating unnecessary problems of waste-management procedures for removing the crystals, and/or causing poor distribution of the agricultural material(s) on the agricultural field.

The use of solvent systems based on a single solvent such as N-methylpyrrolidone (NMP) is known. This solvent enables the dissolution of a large number of agricultural materials, and avoids the formation of crystals, but it is, however, known as presenting hazards, especially for the operatives and users handling it.

The agrochemical industry is looking for new solvent compositions having properties that are satisfactory for agricultural application, like for example, good solubilisation efficiency for agricultural materials as well as low miscibility with water. In addition, the cost of the solvent compositions should generally be modest, and preferably they should have a favourable toxicology and/or eco toxicology profile, in particular low toxicity and/or low hazard potential, and/or low volatility (low VOC—volatile organic compounds) and/or advantageously high degree of biodegradability and/or renewability.

Thus, there is a continuous need for providing solvent systems for agricultural use that:
have a great modularity, i.e. the ability to be used for a large number of agricultural materials,
have a potential for solubilisation of significant quantities of agricultural materials,
have a high compatibility with several agricultural materials combined together, for example in order to enable an enhanced biological efficacy,
avoid the appearance of crystals, even under rigorous conditions, and/or
present a good safety and sustainable profile, with no or low hazard classification and/or ecotoxicology,
   even for complex associations of agricultural materials (e.g., at high loading) or for hydrophobic materials.

Preferably, the solvent systems should also have a good inherent or readily biodegradability and a high Renewable Carbon Index (circularity).

These objectives are achieved with the present invention, a subject-matter of which is a composition comprising:
(i) at least one first solvent of general formula (A):

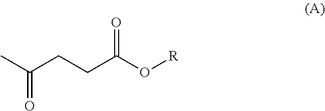

with R representing a linear or branched alkyl group; and
(ii) at least one second solvent of general formula (D):

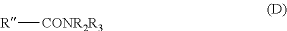

wherein:
   R″ is a linear or branched (C₃-C₁₉)alkyl group, and
   R₂ and R₃, which may be identical or different, denote a hydrogen atom or a (C₁-C₆)alkyl,
   with the proviso that if R₂ is a hydrogen atom, then R₃ is a (C₁-C₆)alkyl.

The solvent compositions according to the invention have a great solubilisation efficiency. In particular, the compositions according to the invention preferably present a good modularity, a good potential for solubilisation of significant quantities of agricultural materials, and a high compatibility with several agricultural materials combined together, in order for example to enable an enhanced biological efficacy. It was noted that the potential for solubilisation of the solvent composition according to the invention was even better for agricultural materials other than the N-(n-butyl)-thiophosphoric triamide (NBPT).

The term “solvent” may especially denote a product that is liquid at the usage temperature, which may contribute to rendering a solid substance liquid, or to preventing/retarding the solidification or crystallisation of material in a liquid form. It may generally have a melting point less than or equal to 20° C., in particular 5° C., for example 0° C.

Further, it has been noted that the compositions according to the invention can preferably guarantee good performances at dilution, even for high loading formulations, and avoid/retard the appearance of crystals, even under rigorous conditions.

In addition, the compositions according to the invention present a good safety and sustainable profile, advantageously with no or low hazard classification and ecotoxicology.

In particular, the solvent compositions according to the invention have preferably a good (inherent or readily) biodegradability, or a high ultimate aerobic biodegradability in soils, and can generally show a high Renewable Carbon Index.

The Renewable Carbon Index (RCI) is a way to quantify the “eco-friendly” profile of ingredients and products. The higher the RCI the better the renewable profile of the ingredient or product is.

A subject-matter of the invention is also the use of the composition according to the invention for preparing an agrochemical formulation.

A subject-matter of the invention is also the use of a composition according to the invention as a solvent, in particular in an agrochemical formulation.

A subject-matter of the invention is also an agrochemical formulation comprising at least one agricultural material and the solvent composition according to the invention.

According to a preferred embodiment of the invention, the agrochemical formulation is an agrochemical formulation with a high concentration of agricultural material(s). The use of concentrated formulations is in particular advantageous for economic reasons (indeed such compositions making it possible to reduce the total weight of the formulations, and consequently their transport costs), the concentrated formulation then being generally diluted to the desired concentration by the final user.

Other characteristics, aspects and advantages of the invention will emerge even more clearly on reading the description and the example that follows.

In the present description, and unless otherwise indicated:
the expression “at least one” is equivalent to the expression “one or more” and can be replaced therewith;
the expression “between” is equivalent to the expression “ranging from” and can be replaced therewith, and implies that the limits are included;
for the purposes of the present invention, the expression “greater than” and respectively the expression “less than” are intended to mean an open range which is strictly greater, respectively strictly less, and therefore that the limits are not included;
the expression “alkyl” refers to an acyclic, linear or branched alkyl with a general formula of CₙH₂ₙ₊₁.

The composition according to the invention is a composition, which can be preferably used as a solvent, comprising the mixture at least one first solvent and at least one second solvent, and preferably at least one third solvent.

### The First Solvent(s)

The composition according to the invention comprises at least one first solvent of general formula (A):

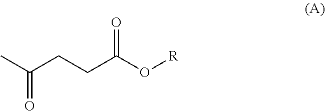

with R representing a linear or branched alkyl group.

The first solvents of the general formula (A) are esters of levulinic acid.

The radical R in formula (A) represents a linear or branched alkyl group containing at least 1 carbon atom, preferably a linear or branched (C₁-C₆)alkyl group.

Generally, the radical R in formula (A) represents a linear or branched alkyl group containing at least 2 carbon atoms, in particular a linear or branched (C₂-C₆)alkyl group. The radical R can be an ethyl group.

More preferably, the radical R in formula (A) represents a linear or branched alkyl group containing at least 3 carbon atoms, in particular a linear or branched (C₃-C₆)alkyl group, for instance a linear (C₃-C₆)alkyl group.

And more advantageously, the radical R in formula (A) represents a linear or branched alkyl group containing at least 4 carbon atoms, in particular a linear or branched (C₄-C₆)alkyl group, and more particularly a linear (C₄-C₆)alkyl group.

Even if the first solvent may be ethyl levulinate (R is an ethyl group), the first solvent is very advantageously butyl levulinate (i.e. R is a linear or branched C₄-alkyl group) and more particularly n-butyl levulinate (i.e. R is a n-butyl group); which butyl levulinate is, in addition to being bio-sourced, advantageously totally non-miscible in water (which is for example preferable to formulate an agrochemical formulation in the form of an emulsifiable concentrate).

Among the examples of solvents of formula (A) that may be used according to the invention, mention may be made of W448001 or preferably W220701 marketed by Sigma-Aldrich, GFbio ReSolv 100 (ethyl levulinate, formerly named NXT SOLV 100) and preferably GFbio ReSolv 200 (butyl levulinate, formerly named NXT SOLV 200) marketed by GF Biochemicals.

Preferably, the total amount of the first solvent(s) of general formula (A) ranges from 5% to 95% by weight, more preferentially from 5% to 90% by weight, even more preferentially from 10% to 85% by weight, better from 15% to 80% by weight, and even better from 20% to 75% by weight, relative to the total weight of the composition.

Preferably, the total amount of butyl levulinate (or ethyl levulinate) ranges from 5% to 95% by weight, more preferentially from 5% to 90% by weight, even more preferentially from 10% to 85% by weight, better from 15% to 80% by weight, and even better from 20% to 75% by weight, relative to the total weight of the composition.

Renewable carbon commonly entails all carbon sources that avoid or substitute the use of any additional fossil carbon from the geosphere. Renewable carbon can come from the biosphere, atmosphere or technosphere, but not from the geosphere.

Renewable carbon is here defined as carbon derived from recently living plant or animal organisms (as opposed to carbon derived from fossil carbon which is coal, oil or petroleum based), as well as carbon derived from CO₂ capture.

Renewable Carbon Index (RCI) is here defined as the value calculated by dividing the number of renewable carbons by the total number of carbons in the entire molecule. For example, if 80% of the number of carbons present in the first solvent is renewable carbon then the RCI is 0.8.

For first solvent blends, the RCI of the first solvents is the weighted average of each first solvent of the blend.

Preferably, the first solvent(s) used in the composition according to the invention has (have) a Renewable Carbon Index (RCI) of at least 0.25, more preferentially of at least 0.3, even more preferentially of at least 0.4, in particular of at least 0.5 and for instance of at least 0.55.

Preferably, butyl levulinate used in a preferred composition according to the present invention has a RCI of at least 0.4, preferably of at least 0.5 and more preferably of at least 0.55.

### The Second Solvent(s)

The composition according to the invention comprises at least one second solvent of general formula (D):

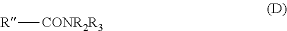

wherein,
   R″ is a linear or branched (C₃-C₁₉)alkyl group, preferably a linear or branched (C₇-C₁₉)alkyl group, more preferentially a linear alkyl group comprising 7, 8 or 9 carbon atoms, and even more preferentially a linear (C₉)alkyl group, and
   R₂ and R₃, which may be identical or different, denote a hydrogen atom or a (C₁-C₆)alkyl, preferably a (C₁-C₄)alkyl, more preferentially a (C₁-C₂)alkyl, and in particular a methyl group, with the proviso that if R₂ is a hydrogen atom, then R₃ is a (C₁-C₆)alkyl.

According to a preferred embodiment, R₂ and R₃ are identical.

According to another preferred embodiment, R″ is a linear alkyl group comprising 7, 8 or 9 carbon atoms, and R₂ and R₃ are identical and denote a (C₁-C₂)alkyl.

More preferentially, the second solvent is N,N-dimethyldecanamide, i.e. wherein R″ is a linear (C₉)alkyl group, and R₂ and R₃ are methyl (as for example Rhodiasolv® ADMA 10, marketed by Solvay).

Preferably, the total amount of second solvent(s) of formula (D) ranges from 1% to 80% by weight, more preferentially from 5% to 75% by weight, even more preferentially from 10% to 70% by weight, in particular from 15% to 65% by weight, for instance from 15% to 50% by weight, for example from 20% to 45% by weight, and even from 20% to 35% by weight, relative to the total weight of the composition.

Preferably, the total amount of N,N-dimethyldecanamide ranges from 1% to 80% by weight, more preferentially from 5% to 75% by weight, even more preferentially from 10% to 70% by weight, in particular from 15% to 65% by weight, for instance from 15% to 50% by weight, for example from 20% to 45% by weight, and even from 20% to 35% by weight, relative to the total weight of the composition.

Preferably, the weight ratio of the total content of first solvent(s) of general formula (A) to the total content of second solvent(s) of general formula (D) ranges from 0.05 to 10; more preferentially from 0.1 to 5; even more preferentially from 0.2 to 4; and in particular from 0.3 to 3.5.

When the composition according to the present invention contains butyl levulinate and N,N-dimethyldecanamide, the weight ratio of the total content of butyl levulinate to the total content of N,N-dimethyldecanamide can preferably range from 0.05 to 10; more preferentially from 0.1 to 5; even more preferentially from 0.2 to 4; and in particular from 0.3 to 3.5.

Generally, the composition according to the invention presents a Renewable Carbon Index (RCI) of at least 0.25, more preferentially of at least 0.3, even more preferentially of at least 0.4, in particular of at least 0.5 and for instance of at least 0.55.

### The Additional Solvent(s)

Preferably, the composition according to the invention further comprises one or more additional solvents.

According to this preference, the composition comprises at least one first solvent of general formula (A), at least one second solvent of general formula (D) and one or more additional solvents different from the solvents of general formula (A) or (D).

More preferentially, the additional solvents which may be used in the composition according to the invention are chosen from:
amide ester solvents, different from solvents of general formula (D),
dioxolane-based solvents,
solvents chosen from levoglucosenone, dihydrolevoglucosenone or a derivative thereof,
aromatic solvents, different from solvents of general formulae (A) or (B),
ester or diester solvents, different from solvents of general formula (A),
alkyl acetate solvents, different from solvents of general formula (A),
sulfoxide solvents, and
mixtures thereof.

Even more preferentially, the additional solvents which may be used in the composition according to the invention are chosen from dioxolane-based solvents, amide esters solvents different from solvents of general formula (D), and mixtures thereof.

Amide ester solvents which may be used in the composition according to the invention are preferably chosen from amide ester solvents of formula (B):

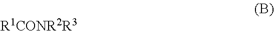

wherein:
   R¹ is a linear or branched, saturated aliphatic group, having from 1 to 6 carbon atoms, substituted by one or more functional groups chosen from —OH groups and/or —COOR′ groups, wherein R′ is a (C₁-C₆)alkyl group, in particular a (C₁-C₄)alkyl group, and more particularly a (C₁-C₂)alkyl group,
   R² and R³, which are identical or different, are a (C₁-C₆)alkyl group, in particular a (C₁-C₄)alkyl group, and more particularly a (C₁-C₂)alkyl group,
   R¹ and R² or R³ may together form a ring, the said ring containing 4 to 6 carbon atoms and optionally substituted by one or more (C₁-C₄)alkyl groups and/or one or more functional groups chosen from —OH groups, —OR′ groups, —COOR′ groups and —CONR⁴R⁵ groups, wherein R′ is a (C₁-C₆)alkyl group, in particular a (C₁-C₄)alkyl group, and more particularly a (C₁-C₂)alkyl group, and R⁴ and R⁵, which are identical or different, denote a (C₁-C₆)alkyl group, in particular a (C₁-C₄)alkyl group, and more particularly a (C₁-C₂)alkyl group.

Preferably, the radical R¹ in formula (B) represents a group having the formula —Z—COOR′ in which R′ is a methyl group and Z is a linear or branched divalent alkylene group comprising from 1 to 6 carbon atoms, in particular from 2 to 4 carbon atoms.

More preferentially, Z is a linear or branched divalent alkylene group comprising 4 carbon atoms, and even more preferentially Z is a branched divalent alkylene group comprising 4 carbon atoms.

According to a preferred embodiment, the amide ester solvents of formula (B) are chosen from those of the following formula (B′):

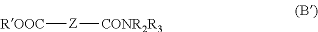

wherein,
   Z is a divalent (C₁-C₆)alkylene, preferably (C₂-C₅)alkylene, more preferentially (C₄)alkylene, and
   R′, R₂ and R₃, identical or different, denote a (C₁-C₆)alkyl, preferably a (C₁-C₄)alkyl, more preferentially a (C₁-C₂)alkyl, and even better a methyl group.

Preferably according to this embodiment, Z in formula (B′) is a divalent (C₄)alkylene, more preferably a divalent alkylene group of formula —CH(CH₃)—CH₂—CH₂—.

Preferably according to this embodiment, R′, R₂ and R₃, are (C₁-C₄)alkyls, in particular methyl, ethyl, propyl, iso-propyl, n-butyl, s-butyl, tert-butyl. And more preferably R′, R₂ and R₃ are identical and notably a (C₁-C₂)alkyl. More advantageously, R′, R₂ and R₃, are identical and denote a methyl group.

Preferably, the amide ester solvent(s) is (are) chosen from compounds of formula (B′), wherein Z is a (C₄)alkylene group, and R′, R₂ and R₃ are methyl groups. Very preferably, the ester-amide solvent comprises at least one compound of formula (B′), wherein Z is an alkylene group of formula —CH(CH₃)—CH₂—CH₂, and R′, R₂ and R₃ are methyl groups.

According to a particularly preferred embodiment, the composition according to the invention further comprises at least one third solvent chosen from amide ester solvents of formula (B) above; preferably from amide ester solvents of formula (B′) above. More preferentially according to this embodiment, the composition according to the invention comprises methyl-5-(dimethylamino)-2-methyl-5-oxopentanoate as third solvent.

Rhodiasolv® Polarclean, marketed by Solvay, is an example of very suitable commercial solvent which can be used as additional solvent in accordance with the invention.

Preferably, the total amount of the amide ester solvent(s) of general formula (B) ranges from 1% to 60% by weight, more preferentially from 5% to 60% by weight, even more preferentially from 10% to 50% by weight, in particular from 10% to 45% by weight, for instance from 20% to 40% by weight, relative to the total weight of the composition.

Preferably, the total amount of the amide ester solvent(s) of general formula (B′) ranges from 1% to 60% by weight, more preferentially from 5% to 60% by weight, even more preferentially from 10% to 50% by weight, in particular from 10% to 45% by weight, for instance from 20% to 40% by weight, relative to the total weight of the composition.

Preferably, the total amount of methyl 5-(dimethylamino)-2-methyl-5-oxopentanoate ranges from 1% to 60% by weight, more preferentially from 5% to 50% by weight, even more preferentially from 10% to 45% by weight, and even better from 20% to 40% by weight, relative to the total weight of the composition.

Dioxolane-based solvents which may be used as additional solvents in the composition according to the invention are preferably chosen from dioxolane-based solvents of formula (C) below:

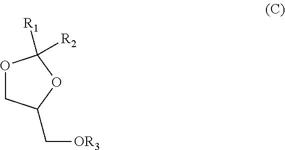

wherein,
R₁ and R₂, independent from one another, are a linear or branched C₁-C₁₂ alkyl, a C₄-C₁₂ cycloalkyl or an aryl,
R₃ is H, a linear or branched (C₁-C₆)alkyl, a (C₃-C₅)cycloalkyl, or a —C(O)R₄ group with R₄ being a linear or branched C₁-C₄ alkyl or C₅-C₆ cycloalkyl.

In a preferred embodiment:
R₁ and R₂, independent from one another, are a linear or branched (C₁-C₁₂)alkyl, and/or
R₃ is H or a linear or branched (C₁-C₆)alkyl.

More preferably according to this embodiment, R₁ and R₂, independent from one another, are a linear or branched (C₁-C₄)alkyl and R₃ is H.

In another preferred embodiment, R₁ and R₂, independently from one another, are selected in the group consisting of: methyl, ethyl, isopropyl, n-propyl, isobutyl, n-butyl, tert-butyl, n-pentyl, cyclopentyl, cyclohexyl or phenyl, and more preferentially methyl.

Advantageously, in formula (C) above R₃ is H or a —C(O)R₄ group, with R₄ being methyl, ethyl, isopropyl, n-propyl, isobutyl, n-butyl or tert-butyl. More preferably, R₃ is H.

One very preferred embodiment is when R₁ and R₂ are methyl and R₃ denotes a hydrogen atom. A corresponding commercial compound is for example Rhodiasolv® Li-Tec 2V (Augeo® SL191) or Solketal. This compound can be synthesized by reaction between glycerol and acetone, under well-known classical conditions. Glycerol can be for instance obtained as a coproduct from biodiesel production during the transesterification of triglycerides.

One embodiment is to have R₁ and R₂ are methyl and R₃ is a —C(O)R₄ group, with R₄ being methyl. A corresponding commercial compound can be synthesized by transesterification of Solketal with an alkyl acetate, under well-known classical conditions.

In another embodiment, R₁ is methyl, R₂ isobutyl and R₃ is H. A corresponding commercial compound can be synthesized by reaction between glycerol and methyl-isobutyl ketone, under well-known classical conditions.

In another particular embodiment, R₁ is methyl, R₂ is phenyl and R₃ is H. The corresponding compound can be synthesized by reaction between glycerol and acetophenone, under well-known classical conditions.

According to a specific embodiment, the compound of formula (C) may be a bio-based compound.

According to another specific embodiment, the at least one dioxolane-based solvent comprises a compound of formula (C) and a compound of formula (C′), wherein R₁, R₂ and R₃ have the same meaning as for formula (C).

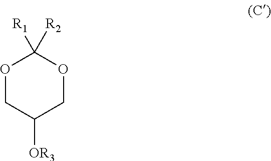

More preferentially, the second solvent of formula (C) is 2,2-dimethyl-4-hydroxymethyl-1,3-dioxolane.

According to a particularly preferred embodiment, the composition according to the invention further comprises at least one third solvent chosen from dioxolane-based solvents of formula (C) above. More preferentially according to this embodiment, the composition according to the invention comprises 2,2-dimethyl-4-hydroxymethyl-1,3-dioxolane as third solvent.

Preferably, the total amount of dioxolane-based solvent(s) of formula (C) ranges from 1% to 50% by weight, more preferentially from 2% to 45% by weight, even more preferentially from 5% to 35% by weight, in particular from 5% to 25% by weight, and for instance from 5% to 15% by weight, relative to the total weight of the composition.

Preferably, the total amount of 2,2-dimethyl-4-hydroxymethyl-1,3-dioxolane ranges from 1% to 50% by weight, more preferentially from 2% to 45% by weight, even more preferentially from 5% to 35% by weight, in particular from 5% to 25% by weight, and for instance from 5% to 15% by weight, relative to the total weight of the composition.

Additional solvents which may be used in the composition according to the invention may be chosen from levoglucosenone, dihydrolevoglucosenone or a derivative thereof.

Levoglucosenone is a bicyclic α, β-unsaturated ketone containing a protected aldehyde. The highly dehydrated sugar is derived from cellulose and hence provides a bio-based solvent, which is attractive as a “green” solvent.

Levoglucosenone, of molecular formula C₆H₆O₃, is ((1 S,5 R)-6,8-dioxabicyclo[3.2.1]oct-2-en-4-one), formula (I) below:

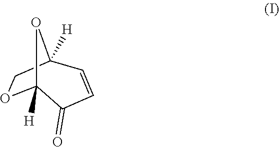

According to the present invention, a derivative means a derivative of levoglucosenone or a derivative of dihydrolevoglucosenone.

Generally, the derivative of levoglucosenone, is a compound which may be synthesized from levoglucosenone, directly and/or indirectly. In other words, levoglucosenone may be a starting material and/or an intermediary material in a synthesis of the derivative of levoglucosenone.

Dihydrolevoglucosenone is derived from levoglucosenone by hydrogenation of levoglucosenone, for example over supported palladium catalysts. Commercially, dihydrolevoglucosenone is available as Cyrene® (RTM) from Circa Group Pty Ltd.

Dihydrolevoglucosenone is a chiral dipolar aprotic solvent. Dihydrolevoglucosenone, of molecular formula C₆H₈O₃, is ((1 S,5 R)-6,8-Dioxabicyclo[3.2.1]octan-4-one), of formula (II) below:

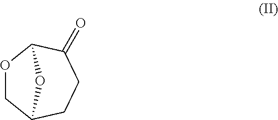

As derivatives of dihydrolevoglucosenone, it can be cited ketal derivatives of dihydrolevoglucosenone, in particular cygnet 0.0 (spiro[6,8-dioxabicyclo[3.2.1]octane-4,2′-[1,3]dioxolane]), cygnet 1.0, cygnet 1.1, cygnet 2.0, cygnet 4.0 (such as those described in “Intelligent approach to solvent substitution: the identification of a new class of levoglucosenone derivatives—Ana Alves Costa Pacheco et al—ChemSusChem, 2016, 9, 3503-3512).

According to a particular embodiment, the composition according to the invention further comprises an additional solvent chosen from levoglucosenone, dihydrolevoglucosenone, derivatives thereof, and mixtures thereof; preferably chosen from levoglucosenone, dihydrolevoglucosenone, and mixtures thereof.

According to a particularly preferred embodiment, the composition according to the invention further comprises dihydrolevoglucosenone.

According to a specific embodiment, the composition according to the invention comprises ethyl levulinate, N,N-dimethyldecanamide and dihydrolevoglucosenone.

According to another specific embodiment, the composition according to the invention comprises butyl levulinate (particularly n-butyl levulinate), N,N-dimethyldecanamide and dihydrolevoglucosenone.

Preferably, when there are present in the composition, the total amount of levoglucosenone, dihydrolevoglucosenone and derivatives thereof ranges from 5% to 60% by weight, more preferentially from 8% to 50% by weight, even more preferentially from 10% to 45% by weight, in particular from 10% to 40% by weight, and for instance from 20% to 40% by weight, relative to the total weight of the composition.

Preferably, the total amount of dihydrolevoglucosenone ranges from 5% to 60% by weight, more preferentially from 8% to 50% by weight, even more preferentially from 10% to 45% by weight, in particular from 10% to 40% by weight, and for instance from 20% to 40% by weight, relative to the total weight of the composition.

Aromatic solvents which may be used in the composition according to the invention are different from solvents of general formulae (A) or (B) as defined above.

Among the aromatic solvents, mention may be made of toluene, xylene and mixtures of C₈-C₁₂ di- and tri-alkylbenzenes like Solvesso®.

Among the aromatic hydrocarbons, mention may be made of alkylbenzenes such as toluene, dialkylbenzenes such as xylene, polynuclear aromatic hydrocarbons such as naphthalenes, alkyl naphthalenes (for example dimethylnaphthalene), dialkylnaphthalenes, trialkylnaphtalenes such as dimethylmonoisopropylnaphtalene and phenylxylylethane, as well as mixtures thereof.

The majority of these hydrocarbons are obtained by fractionation of crude oil and, in general, have distillation ranges comprised from about 135° C. to about 305° C., those with distillation temperatures of about 183° C. to about 290° C. being preferred.

Among the aromatic hydrocarbons, the following commercial products may also be mentioned: Nisseki Hisol SAS-296 (a mixture of 1-phenyl-1-xylylethane and 1-phenyl-1-ethylphenylethane, Nippon Oil Corporation), Cactus Solvent HP-MN (methylnaphthalene 80%, Japan Energy Corporation), Cactus Solvent HP-DMN (dimethylnaphthalene 80%, Japan Energy Corporation), Cactus Solvent P-100 (alkylbenzene with 9 to 10 carbon atoms, Japan Energy Corporation), Cactus Solvent P-150 (alkylbenzene, Japan Energy Corporation), Cactus Solvent P-180 (a mixture of methylnaphthalene and dimethylnaphthalene, Japan Energy Corporation), Cactus Solvent P-200 (a mixture of methylnaphthalene and dimethylnaphthalene, Japan Energy Corporation), Cactus Solvent P-220 (a mixture of methylnaphthalene and dimethylnaphthalene, Japan Energy Corporation), Cactus Solvent PAD-1 (dimethylmonoisopropylnaphtalene, Japan Energy Corporation), Solvesso® 100 (aromatic hydrocarbon, Exxon Mobil Corporation), Solvesso® 150 (aromatic hydrocarbon, Exxon Mobil Corporation), Solvesso® 200 (aromatic hydrocarbon, ExxonMobil Corporation), Ultra Low Naphtalene Aromatic150 (ExxonMobil Chemical Company), Ultra Low Naphtalene Aromatic 200 (ExxonMobil Chemical Company), Solvesso® 150 ND (aromatic hydrocarbon, Exxon Mobil Corporation), Solvesso® 200 ND (aromatic hydrocarbon, Exxon Mobil Corporation) Swasol 100 (toluene, Maruzen Petrochemical Co Ltd) and Swasol 200 (xylene, Maruzen Petrochemical Co Ltd).

Mention may be made in particular of the mixtures of C₈-C₁₂ di- and tri-alkylbenzenes with a flash point of at least 60.5° C.

Such mixtures are commercially available, in particular from Exxon Mobil under the names Solvesso® 150 and Solvesso® 200.

According to one preferred embodiment, the aromatic solvent is acetophenone.

Preferably, the total amount of aromatic solvents, different from solvents of general formulae (A) or (B), ranges from 1% to 60% by weight, more preferentially from 2% to 50% by weight, even more preferentially from 5% to 40% by weight, in particular from 10% to 30% by weight, relative to the total weight of the composition.

Preferably, the total amount of C₈-C₁₂ di- and tri-alkylbenzenes ranges from 1% to 60% by weight, more preferentially from 2% to 50% by weight, even more preferentially from 5% to 40% by weight, in particular from 10% to 30% by weight, relative to the total weight of the composition.

Preferably, the total amount of acetophenone ranges from 1% to 60% by weight, more preferentially from 2% to 50% by weight, even more preferentially from 5% to 40% by weight, in particular from 10% to 30% by weight, relative to the total weight of the composition.

Ester or diester solvents which may be used in the composition according to the invention are different from solvents of general formula (A) as defined above.

Among the ester or diester solvents, mention may be made of 2-ethylhexyl lactate, esters of fatty acids, fatty esters of carboxylic acids, mixtures of methyl diesters of 2-ethyl succinic acid, methylglutaric acid and possibly adipic acid, such as Rhodiasolv® IRIS (mixture comprising of 70% to 95% by weight of dimethyl 2-methyl glutarate, 5% to 30% by weight of dimethyl ethylsuccinate and 0% to 10% by weight of dimethyl adipate) and mixtures of dimethyl glutarate (for instance from 60% to 70% by weight), dimethyl succinate (for instance from 20% to 30% by weight) and dimethyl adipate (for instance from 10% to 15% by weight), such as Rhodiasolv® RPDE.

According to one embodiment, the compositions according to the invention comprise a fatty acid ester, for example a canola oil ester, and in particular a canola oil methyl ester.

According to one embodiment, the ester or diester solvents of the compositions according to the invention are carboxylic acid esters, preferably mixtures of several carboxylic acid esters.

Preferably, the ester or diester solvents of the compositions according to the invention correspond to the formula R_{α}OOC-A-COOR_{α}, where R_{α} represents a linear or branched alkyl group comprising of 1 to 6 carbon atoms, and preferably represents a methyl group, and A represents a linear or branched alkylene group comprising of 2 to 4 carbon atoms.

According to one embodiment, the ester or diester solvent is the compound Rhodiasolv® IRIS.

Preferably, the total amount of ester or diester solvents, different from solvents of general formula (A), ranges from 1% to 50% by weight, more preferentially from 2% to 40% by weight, even more preferentially from 5% to 35% by weight, in particular from 10% to 30% by weight, relative to the total weight of the composition.

Alkyl acetate solvents which may be used as additional solvents in the composition according to the invention are different from the first solvents of general formula (A) as defined above.

Preferably, the alkyl group of the alkyl acetate solvents contains at least 3 carbon atoms.

More preferentially, the alkyl group of the alkyl acetate solvents is a, linear or branched, C₆-C₁₅ alkyl group; even more preferentially, a C₆-C₁₃ alkyl group; and better a C₆-C₁₂ alkyl group.

Mention may preferably be made especially of cyclohexyl or hexyl (n-hexyl), ethylhexyl, especially 2-ethylhexyl, octyl (n-octyl), isooctyl, decyl (n-decyl), isodecyl, tridecyl, dodecyl and 18 undecyl.

Preferably, the total amount of alkyl acetate solvents, different from solvents of general formula (A), ranges from 1% to 50% by weight, more preferentially from 2% to 40% by weight, even more preferentially from 5% to 35% by weight, in particular from 10% to 30% by weight, relative to the total weight of the composition.

Sulfoxide solvent which may be used in the composition according to the invention is preferably dimethyl sulfoxide (DMSO).

Preferably, the total amount of sulfoxide solvents, ranges from 1% to 50% by weight, more preferentially from 2% to 40% by weight, even more preferentially from 5% to 35% by weight, in particular from 10% to 30% by weight, relative to the total weight of the composition.

Preferably, the total amount of dimethyl sulfoxide, ranges from 1% to 50% by weight, more preferentially from 2% to 40% by weight, even more preferentially from 5% to 35% by weight, in particular from 10% to 30% by weight, relative to the total weight of the composition.

According to a preferred embodiment of the invention, the composition comprises:
(i) at least one first solvent of general formula (A) as described above, in particular ethyl levulinate or butyl levulinate, preferably butyl levulinate, (ii) at least one second solvent of general formula (D) as described above, preferably N,N-dimethyldecanamide,
(iii) at least one amide ester solvent of formula (B) as described above, preferably methyl 5-(dimethylamino)-2-methyl-5-oxopentanoate, and
(iv) optionally at least one additional solvent chosen from levoglucosenone, dihydrolevoglucosenone, derivatives thereof, and mixtures thereof, preferably dihydrolevoglucosenone.

According to another preferred embodiment of the invention, the composition comprises:
(i) at least one first solvent of general formula (A) as described above, in particular ethyl levulinate or butyl levulinate, preferably butyl levulinate,
(ii) at least one second solvent of formula (D) as described above, preferably N,N-dimethyldecanamide,
(iii) at least one dioxolane-based solvent of formula (C) as described above, preferably 2,2-dimethyl-4-hydroxymethyl-1,3-dioxolane, and
(iv) optionally at least one additional solvent chosen from levoglucosenone, dihydrolevoglucosenone, derivatives thereof, and mixtures thereof, preferably dihydrolevoglucosenone.

According to another preferred embodiment of the invention, the composition comprises:
(i) at least one first solvent of general formula (A) as described above, in particular ethyl levulinate or butyl levulinate, preferably butyl levulinate,
(ii) at least one second solvent of formula (D) as described above, preferably N,N-dimethyldecanamide,
(iii) at least one amide ester solvent of general formula (B) as described above, preferably methyl 5-(dimethylamino)-2-methyl-5-oxopentanoate,
(iv) at least one dioxolane-based solvent of formula (C) as described above, preferably 2,2-dimethyl-4-hydroxymethyl-1,3-dioxolane, and
(v) optionally at least one additional solvent chosen from levoglucosenone, dihydrolevoglucosenone, derivatives thereof, and mixtures thereof, preferably dihydrolevoglucosenone.

According to another preferred embodiment of the invention, the composition comprises:
from 10% to 85% by weight, in particular from 10% to 80% by weight, relative to the total weight of the composition, of ethyl levulinate or preferably butyl levulinate as first solvent,
from 1% to 80% by weight, in particular from 10% to 70% by weight, relative to the total weight of the composition, of N,N-dimethyldecanamide as second solvent,
optionally one or more additional solvents chosen from methyl 5-(dimethylamino)-2-methyl-5-oxopentanoate, 2,2-dimethyl-4-hydroxymethyl-1,3-dioxolane, and mixtures thereof, and
optionally dihydrolevoglucosenone.

According to another preferred embodiment of the invention, the composition comprises:
(i) at least one first solvent of general formula (A) as described above, in particular ethyl levulinate or butyl levulinate,
(ii) at least one second solvent of formula (D) as described above, preferably N,N-dimethyldecanamide, and
(iii) at least one additional solvent chosen from levoglucosenone, dihydrolevoglucosenone, derivatives thereof, and mixtures thereof, preferably dihydrolevoglucosenone

According to a particular embodiment, the composition according to the invention consists in at least one first solvent of general formula (A) and at least one second solvent of general formula (D) and optionally at least one additional solvent, as described previously.

The present invention also relates to the use of a composition as defined above as a solvent, preferably in an agrochemical formulation, and more particularly relates to the use of a composition as defined above for preparing an agrochemical formulation.

### The Agrochemical Formulation

The agrochemical formulation according to the present invention comprises:
a) at least one agricultural material,
b) a composition as described above,
c) optionally at least one emulsifier, preferably a surfactant, and
d) optionally water.

An “agrochemical formulation” is intended to denote a composition which, either use in its concentrated form or in dilution in water to a targeted use rate, causes or provides a beneficial and/or a useful effect in agriculture and/or provides a biological activity in a seed, a plant, soil, for example to seeds to control pests and/or to regulate the growth of plants and/or to induce the defense response in plants and/or to enhance metabolic and physiological processes within plants and soils. The agrochemical formulation is for example described in T. Tadros (ed.), Encyclopedia of Colloid and Interface Science, Springer-Verlag Berlin Heidelberg, 2013, pp. 3-80.

According to the invention, the “agrochemical formulation” is a composition comprising the solvent composition according to the invention and at least one agricultural material; optionally at least one emulsifier, preferably a surfactant, and optionally water.

As mentioned previously, agriculture uses many agricultural materials. They are also referred to as active plant-protection products or active materials or active substances.

As used herein, the term “agricultural material” means an active ingredient used in particular to the practice of farming, including cultivation of the soil for the growing of crops. However, the use of agricultural materials is not limited to application to crops. Agricultural materials may be applied to any surface, e.g., for the purpose of cleaning or aiding or inhibiting growth of a living organism. Other non-crop applications include, but are not limited to, application to an animal, e.g. livestock, application to turf and ornamentals, and application to railroad weed.

Agricultural materials are generally products in pure or highly concentrated form, generally not soluble in water and known to the person skilled in the art.

Depending on the water solubility of the agricultural materials and their loading in the targeted formulation, it can be very challenging to identify suitable solvents to obtain a chemically and physically stable formulation.

For agricultural materials with a low or relatively low water solubility, the use of appropriate solvents is therefore interesting to prepare concentrated liquid formulations. Such concentrated formulations of agricultural materials are generally diluted prior to agricultural use. The dilution effected by the farmer is generally performed by mixing the agrochemical formulation with water.

Preferably, the agricultural materials are water-insoluble agricultural materials, at 20° C. and at atmospheric pressure (i.e., 1.013×10⁵ Pa).

More preferentially, the agricultural materials are soluble in water to no more than 100 g/L, even more preferentially no more than 20 g/L, in particular no more than 5 g/L, for instance no more than 1 g/L and even no more than 0.2 g/L, at 20° C. and at atmospheric pressure (i.e., 1.013×10⁵ Pa).

Preferably, the agricultural materials are chosen from pesticides, nutrients, biostimulants, plant growth regulators, and mixtures thereof.

Advantageously, the agrochemical formulation according to the invention may comprise at least one pesticide.

For example, these pesticides may be chosen from herbicides, fungicides, insecticides, acaricides, algicides, molluscicides, miticides, nematicides, biocides and rodenticides.

The person skilled in the art is familiar with such pesticides. Specific examples of pesticides can be found in the book “Sittig's handbook of Pesticides and Agricultural Chemicals”, 2^{nd} edition, William Andrew Publishing, 2015.

The agrochemical formulation according to the invention may optionally comprise at least one nutrient.

Nutrients refer to chemical elements and compounds which are desired or necessary to promote or improve plant growth. Nutrients generally are described as macronutrients or micronutrients.

Suitable nutrients for use in the agrochemical formulations according to the invention may be micronutrient compounds, preferably those which are solid at room temperature (20° C.) or are partially soluble.

Micronutrients typically refer to trace metals or trace elements, and are often applied in lower doses. Suitable micronutrients include trace elements selected from zinc, boron, chlorine, copper, iron, molybdenum, and manganese.

The micronutrients may be in a soluble form or included as insoluble solids, and may be in the form of salts or chelates. Preferably, the micronutrient is in the form of a carbonate or oxide.

Preferably, the micronutrients may be selected from zinc, calcium, molybdenum or manganese, or magnesium. More preferentially micronutrients for use in the agrochemical formulation according to the invention may be selected from zinc oxide, manganese carbonate, manganese oxide, or calcium carbonate.

The agrochemical formulation according to the present invention may further comprise at least one macronutrient.

Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as urean type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

The agrochemical formulation according to the invention may optionally comprise at least one biostimulant.

The term “biostimulant” is preferably intended to mean a compound which may enhance metabolic or physiological processes such as respiration, photosynthesis, nucleic acid uptake, ion uptake, nutrient delivery, or a combination thereof.

Generally, this is a substance or microorganism that, when applied to seeds, plants or on the rhizosphere, can stimulate natural processes to enhance or benefit nutrient uptake, nutrient use efficiency, tolerance to abiotic stress, or crop quality and yield.

Non-limiting examples of biostimulants include seaweed extracts (e.g., ascophyllum nodosum), humic acids (e.g., potassium humate), fulvic acids, myoinositol, glycine, and combinations thereof.

The agrochemical formulation according to the invention may optionally comprise at least one plant growth regulator.

Plant growth regulators mean active ingredients used to influence the growth characteristics of plants. Examples of plant growth regulators which may be used in the present invention include, but are not limited to: 1-naphthaleneacetic acid, 1-naphthaleneacetic acid-salt, 1-napthol, 2,4-dichlorophenoxyacetic acid (2,4-D), 2,4-DB, 2,4-DEP, 2,3,5-triiodobenzoic acid, 2,4,5-trichlorophenoxyacetic acid, 2-naphthoxyacetic acid, 2-naphthoxyacetic acid sodium salt, 3-chloro-4-hydroxyphenylacetic acid, 3-indoleacetic acid, 4-biphenylacetic acid, 4-chlorophenoxyacetic acid (4-CPA), 4-hydroxyphenylacetic acid, 6-benzylaminopurine, auxindole, a-naphthaleneacetic acid K-salt, β-naphfhoxyacetic acid, p-chlorophenoxyacetic acid, dicamba, dichlorprop, fenoprop, indole-3-acetic acid (IAA), indole-3-acetyl-DL-aspartic acid, indole-3-acetyl-DL-tryptophan, indole-3-acetyl-L-alanine, indole-3-acetyl-L-valine, indole-3-butyric acid (IBA), indole-3-butyric acid K-salt, indole-3-propionic acid; a-naphthaleneacetic acid, methyl indole-3-acetate, naphthaleneacetamide, naphthaleneacetic acid (NAA), phenylacetic acid, picloram, potassium naphthenate, sodium naphthenate, 4-hydroxyphenethyl alcohol, 4-CPPU, 6-benzylaminopurine (BA), 6-(Y,Y-dimethylallylamino)purine (2iP), 2-iP-2HCl, adenine, adenine hemisulfate, benzyladenine, kinetin, meta-topolin, N6-benzoyladenine, N-benzyl-9-(2-tetrahydropyranyl) adenine (BP A), N-(2-chloro-4-pyridyl)-N-phenylurea, gibberellic acid (GA3), gibberellins, gibberellins A4+A7 (GA n), ethylene and abscisic acid.

It is possible to combine several agricultural materials in one agrochemical formulation according to the invention.

Preferably, the amount of agricultural material(s) in the agrochemical formulation ranges from 0.01 to 90% by weight, more preferentially from 0.1 to 80% by weight; even more preferentially from 0.5 to 70% by weight; better from 1 to 65% by weight, in particular from 5 to 60% by weight, and for instance from 10 to 60% by weight, relative to the total weight of the agrochemical formulation.

According to a first embodiment of the invention (concentrated composition), the total content of agricultural material(s) in the agrochemical formulation ranges from 5 to 90% by weight, more preferentially from 5 to 70% by weight, even more preferentially from 5 to 60% by weight, and in particular from 10 to 60% by weight, relative to the total weight of the agrochemical formulation.

According to a second embodiment of the invention (diluted composition), the total content of additional agricultural material(s) in the agrochemical formulation ranges from 0.01 to 3% by weight, more preferentially from 0.05 to 2% by weight, and even more preferentially from 0.1 to 1% by weight, relative to the total weight of the agrochemical formulation.

The agrochemical formulation according to the invention comprises one solvent composition as described previously.

Preferably, the solvent composition according to the invention represents from 10% to 99% by weight, more preferentially from 20% to 95% by weight, in particular from 30% to 90% by weight, for instance from 30 to 80% by weight, relative to the total weight of the agrochemical formulation.

The agrochemical formulation according to the invention may optionally comprise at least one emulsifier.

Emulsifiers are agents that are intended to facilitate emulsification after the formulation is placed in the presence of water, and/or stabilisation (over time and/or in temperature) of the emulsion, for example by avoiding separation of the phases.

Preferably, the agrochemical formulation according to the invention further comprises at least one surfactant.

Advantageously, the surfactants that may be used in the invention are chosen from anionic, non-ionic, cationic, amphoteric or zwitterionic surfactants, and mixtures thereof.

More preferentially, the surfactants are chosen from anionic surfactants, non-ionic surfactants, and mixtures thereof.

Even better, the surfactants are chosen from anionic surfactants, polyalkoxylated non-ionic surfactants, and mixtures thereof.

The emulsifiers and surfactants that may be used are different from the agricultural materials.

By way of examples of anionic surfactants, mention may be made without any intended limitation thereto, of:
alkylsulfonic acids, arylsulfonic acids, optionally substituted with one or more hydrocarbon groups, and the acid function of which is partly or totally salified, like C₈-C₅₀ alkylsulfonic acids, more particularly C₅-C₃₀, preferably C₁₀-C₂₂ alkylsulfonic acids, benzenesulfonic acids, naphthalenesulfonic acids, substituted with one to three C₁-C₃₀, preferably C₄-C₁₆ alkyl and/or C₂-C₃₀, preferably C₄-C₁₆ alkenyl groups,
mono- or di-esters of alkylsulfosuccinic acids, of which the linear or branched alkyl portion is optionally substituted with one or more linear or branched C₂-C₄hydroxylated and/or alkoxylated (preferably ethoxylated, propyxylated, ethopropoxylated) groups,
phosphate esters more particularly selected from among those comprising at least one linear or branched, saturated, unsaturated or aromatic hydrocarbon group, comprising 8 to 40 carbon atoms, preferably 10 to 30, optionally substituted with at least one alkoxylated (ethoxylated, propoxylated, ethopropoxylated) group. In addition, they comprise at least one phosphate ester group, mono- or di-esterified such that it is possible to have one or two free or partly or totally salified groups. The preferred phosphate esters are of the type of the mono- and di-esters of phosphoric acid and of alkoxylated (ethoxylated and/or propoxylated) mono-, di- or tri-styrylphenol, or alkoxylated (ethoxylated and/or propoxylated) mono-, di- or trialkylphenol, optionally substituted with one to four alkyl groups; of phosphoric acid and of an alkoxylated (ethoxylated or ethopropoxylated) C₅-C₃₀, preferably C₁₀-C₂₂ alcohol; of phosphoric acid and of a non-alkoxylated C₅-C₂₂, preferably C₁₀-C₂₂ alcohol,
sulfate esters obtained from saturated or aromatic alcohols optionally substituted with one or more alkoxylated (ethoxylated, propoxylated, ethopropoxylated) groups, and for which the sulfate functions appear in the free acid form, or are partly or totally neutralised. As an example, mention may be made of sulfate esters more particularly obtained from saturated or unsaturated C₈-C₂₀ alcohols, which may comprise 1 to 8 alkoxylated (ethoxylated, propoxylated, ethopropoxylated) units; sulfate esters obtained from polyalkoxylated phenol, substituted with 1 to 3 saturated or unsaturated C₂-C₃₀ hydroxycarbon groups, and in which the number of alkoxylated units is comprised between 2 and 40; the sulfate esters obtained from polyalkoxylated mono-, di- or tri-styrylphenol in which the number of alkoxylated units varies from 2 to 40.

The anionic surfactants may be in the acid form (they are potentially anionic), or in a partly or totally salified form with one counter-ion. The counter-ion may be an alkali metal, such as sodium or potassium, an alkaline earth metal, such as calcium, or moreover even an ammonium ion of formula N(R)₄⁺ in which the R groups, either identical or different, represent a hydrogen atom or a C₁-C₄ alkyl group optionally substituted with an oxygen atom.

By way of examples of non-ionic surfactants, mention may be made without any intended limitation thereto, of:
polyalkoxylated (ethoxylated, propoxylated, ethopropoxylated) phenols substituted with at least one C₄-C₂₀, preferably C₄-C₁₂ alkyl group, or substituted with at least one alkylaryl group, the alkyl portion of which is a C₁-C₆ alkyl. More particularly, the total number of alkloxylated units is comprised between 2 and 100.

As an example, mention may be made of polyalkoxylated mono-, di- or tri-(phenylethyl) phenols, or polyalkoxylated nonylphenols. Amongst the ethoxylated and/or propoxylated, sulfated and/or phosphated di- or tri-styrylphenols, mention may be made of ethoxylated di-(phenyl-1-ethyl)phenol, containing 10 oxyethylene units; ethoxylated di-(phenyl-1-ethyl)phenol, containing 7 oxyethylene units; sulfated ethoxylated di-(phenyl-1-ethyl)phenol, containing 7 oxyethylene units; ethoxylated tri-(phenyl-1-ethyl)phenol, containing 8 oxyethylene units; ethoxylated tri-(phenyl-1-ethyl)phenol, containing 16 oxyethylene units; sulfated ethoxylated tri-(phenyl-1-ethyl)phenol, containing 16 oxyethylene units; ethoxylated tri-(phenyl-1-ethyl)phenol, containing 20 oxyethylene units; phosphated ethoxylated tri-(phenyl-1-ethyl) phenol, containing 16 oxyethylene units.
polyalkoxylated (ethoxylated, propyxylated, ethopropoxylated) C₆-C₂₂ fatty acids or alcohols. The number of alkoxylated units is comprised between 1 and 60. The term ethoxylated fatty acid includes both the products obtained by ethoxylation of a fatty acid by ethylene oxide as well as those obtained by esterification of a fatty acid by a polyethylene glycol.
polyalkoxylated (ethoxylated, propoxylated, ethopropoxylated) triglycerides of vegetable or animal origin. Thus, may be included triglycerides from lard, tallow, ground nut oil, butter oil, cotton seed oil, flax oil, olive oil, palm oil, grapeseed oil, fish oil, soya bean oil, castor oil, rapeseed oil, coprah oil, coconut oil, and comprising a total number of alkoxylated units comprised between 1 and 60. The term ethoxylated triglyceride makes reference both to products obtained by ethoxylation of a triglyceride with ethylene oxide as well as to those obtained by transesterification of a triglyceride with a polyethylene glycol.
sorbitan esters, optionally polyalkoxylated (ethoxylated, propoxylated, ethopropoxylated), more particularly the cyclised sorbitol esters of C₁₀-C₂₀fatty acids such as lauric acid, stearic acid, or oleic acid, and comprising a total number of alkoxylated units comprised between 2 and 50.

Useful emulsifiers are in particular the following products, all marketed by Solvay:
Soprophor® TSP/724: a surfactant based on ethopropoxylated tristyrylphenol,
Soprophor® 796/P: a surfactant based on ethopropoxylated tristyrylphenol
Soprophor® CY 8: a surfactant based on ethoxylated tristyrylphenol
Soprophor® BSU: a surfactant based on ethoxylated tristyrylphenol
Soprophor® S/25: a surfactant based on ethoxylated tristyrylphenol
Soprophor® 3D33: a surfactant based on ethoxylated tristyrylphenol phosphate
Alkamuls® RC: a surfactant based on ethoxylated castor oil
Alkamuls® OR/36: a surfactant based on ethoxylated castor oil
Alkamuls® V02003: a surfactant based on ethoxylated castor oil
Alkamuls® OL40: a surfactant based on ethoxylated sorbitan hexaoleate
Alkamuls® T/20: a surfactant based on ethoxylated sorbitan ester.
Geronol® TBE724: a surfactant based on ethopropoxylated tristyrylphenol
Geronol® TEB25: a mixture of surfactants based on ethoxylated castor oil, calcium dodecyl benzene sulfonate and alkoxylated polymers
Rhodacal® 60/B: a surfactant based on dodecylbenzene sulphonate
Rhodacal® 60/BE: a surfactant based on dodecylbenzene sulphonate.

Preferably, the total amount of emulsifier(s) in the agrochemical formulation according to the invention, ranges from 0.05% to 40% by weight, more preferentially from 0.1% to 35% by weight, even more preferentially from 0.5% to 30% by weight, in particular from 1 to 25% by weight, and for instance from 1 to 5% by weight, relative to the total weight of the agrochemical formulation.

Preferably, the total amount of surfactant(s) in the agrochemical formulation according to the invention, ranges from 0.05% to 40% by weight, more preferentially from 0.1% to 35% by weight, even more preferentially from 0.5% to 30% by weight, in particular from 1 to 25% by weight, and for instance from 1 to 5% by weight, relative to the total weight of the agrochemical formulation.

Preferably, the total amount of anionic surfactant(s) in the agrochemical formulation according to the invention, ranges from 0.05% to 40% by weight, more preferentially from 0.1% to 35% by weight, even more preferentially from 0.5% to 30% by weight, in particular from 1 to 25% by weight, and for instance from 1 to 5% by weight, relative to the total weight of the agrochemical formulation.

Preferably, the total amount of non-ionic surfactant(s), in particular polyalkoxylated non-ionic surfactant(s) in the agrochemical formulation according to the invention, ranges from 0.05% to 40% by weight, more preferentially from 0.1% to 35% by weight, even more preferentially from 0.5% to 30% by weight, in particular from 1 to 25% by weight, and for instance from 1 to 5% by weight, relative to the total weight of the agrochemical formulation.

Advantageously, the agrochemical formulation according to the invention may further comprise at least one co-solvent.

According to the present invention, the co-solvents that may be used are different from the first solvents, the second solvents and the additional solvents, as described previously.

These other solvents or co-solvents are preferably selected from:
linear or branched, saturated or unsaturated, aliphatic hydrocarbons, possibly containing a halogen-, phosphorus-, sulfur- and/or nitrogen atom and/or a functional group,
carbocyclic or heterocyclic hydrocarbons, whether saturated, unsaturated or aromatic, possibly containing a halogen-, phosphorus-, sulfur- and/or nitrogen atom and/or a functional group,

More preferentially, the co-solvents are chosen from:
alkanes, cycloalkanes and aromatic derivatives, for example paraffins with a branched chain or straight chain such as “white oil” or decalin; mono-, di- or tri alkyl benzenes or naphthalenes, the compounds sold under the trade name Solvesso® 100, 150, 200 standard and ND grades;
aliphatic, cycloaliphatic or aromatic mono-, di- or tri-esters, for example alkyl alkanoates such as methyl oleate; benzyl alkanoates; alkyl benzoates; gamma butyrolactone; caprolactone; esters of glycerol and citric acid; alkyl salicylates; phthalates; dibenzoates; acetoacetates; glycol ether acetates, dipropylene glycol diacetate;
alkyl mono-, di-, or tri-phosphates such as for example triethyl phosphate;
tributyl phosphate; or tri-2-ethylhexylphosphate;
aliphatic, cycloaliphatic or aromatic ketones such as for example dialkyl ketones; benzyl ketones; fenchone; actetophenone; cyclohexanone; alkyl cyclohexanones;
aliphatic, cycloaliphatic or aromatic alcohols such as for example glycols; 2-ethylhexanol; cyclohexanol; benzyl alcohols; tetrahydrofurfuryl alcohol;
aliphatic, cycloaliphatic or aromatic ethers such as for example ethers of glycol, notably ethylene and propylene glycol, and their polymers; diphenyl ether, dipropylene glycol; monomethyl or monobutyl ether, monobutyl ether of tripropylene glycol; alkoxyalkanols; dimethyl isosorbide;
fatty acids such as for example linoleic acid, linolenic acid, oleic acid;
carbonates such as for example propylene or butylene carbonate; lactates;
fumarates, succinates, adipates, maleates;
amides such as for example alkyldimethylamides, dimethyl-decanoamide;
alkyl ureas;
amines such as for example alkanolamines, morpholine; N-alkyl-pyrrolidones;
tetramethyl sulfone;
dimethyl sulfoxide;
halogenoalkanes or halogenated aromatic solvents such as for example chloroalkanes or chlorobenzene.

Crystallisation inhibitors may also be present in the agrochemical formulations according to the invention. Crystallisation inhibitors may be the co-solvents mentioned here above. Crystallisation inhibitors may also be non-polyalkoxylated fatty alcohols or fatty acids, for example mention may be made of the product Alkamuls® OL700 marketed by Solvay, alkanolamides, polymers etc.

The agrochemical formulation according to the invention may further contain one or more additives different from the ingredients described previously, and which are preferably chosen from viscosity modifying agents, suspending agents, antifoam agents and defoamers, in particular silicone antifoams and defoamers, anti-rebound agents, anti-leaching agents, penetration adjuvants, inert fillers, in particular mineral fillers, binders, diluents, anti-freeze agents, stabilisers, dyes, emetic agents, stickers (adhesion promoters), absorbents, dispersants, disintegration agents, wetting agents, preservatives and/or anti-microbials.

Each additive can be present in the agrochemical composition according to the invention in an amount ranging from 0% to 20% by weight, more preferably from 0% to 10% by weight, relative to the total weight of the composition. Each additive can be for instance present in agrochemical composition according to the invention in an amount ranging from 0.1% to 20% by weight, in particular from 0.1% to 10% by weight, relative to the total weight of the composition. Each additive can be present in the composition according to the invention in an amount preferably ranging from 0% to 5% by weight, notably from 0.1% to 5% by weight, relative to the total weight of the composition. A person skilled in the art will be able to choose these optional additives and their amounts so that they do not harm the properties of the agrochemical compositions of the present invention.

Advantageously, the agrochemical formulation according to the invention is in a liquid form, at 20° C. and at atmospheric pressure (i.e., 1.013×10⁵ Pa) and may be in the form of a concentrate of agricultural material(s), a diluted concentrate, or a sprayable diluted.

Different types of formulation may be used according to the different agricultural materials according to the invention. The formulations that it is possible to use depend on the physical form of the agricultural materials (for example solid or liquid) and on its physicochemical properties in the presence of other compounds such as water or solvents.

For practical reasons (for example for reasons of ease of handling), it may be preferred to use formulations in liquid form. Depending on the physicochemical properties of the different agricultural materials considered, formulations can be in the form of emulsifiable concentrates (EC), concentrated emulsions in water (EW), microemulsions (ME), suspoemulsions (SE), oil dispersions (OD), dispersible concentrates (DC), suspension concentrates (SC), capsule suspensions (CS), soluble liquids (SL), flowable concentrates for seed treatments (FS).

Preferably, the agrochemical formulation according to the invention is in the form of an emulsifiable concentrate (EC), concentrated emulsion in water (EW), microemulsion (ME), suspoemulsion (SE), oil dispersion (OD), dispersible concentrate (DC), capsule suspension (CS), soluble liquid (SL).

Even more preferentially, the agrochemical formulation according to the invention is in the form of an emulsifiable concentrate, an emulsion in water concentrate, a microemulsion concentrate, a suspoemulsion concentrate, an oil dispersion concentrate or a dispersible concentrate.

Even better, the agrochemical formulation according to the invention is in the form of an emulsifiable concentrate (EC).

In particular, it was noted that compositions (outside the invention) comprising a solvent of general formula (B) and ethyl lactate instead of a first solvent of general formula (A), were difficult to formulate in the form of an emulsifiable concentrate (EC); probably due to the high miscibility in water of ethyl lactate.

The agrochemical formulation according to the invention is generally a concentrated agrochemical formulation and is intended to be spread out over a cultivated field or a field to be cultivated, most often after dilution with water, in order to obtain a diluted composition. Dilution is generally carried out by the farm operator, directly in a tank (“tank-mix”), for example in the tank of a device intended to spread out the composition. This does not exclude the possibility of the farm operator adding other plant-protective products, for example fungicides, herbicides, pesticides, insecticides, fertilisers, adjuvants, etc. Thus, the formulation may be used for preparing a formulation diluted in water of the agricultural material, by mixing at least one part by weight of concentrated formulation with at least 10 parts of water, preferably less than 10,000 parts. The dilution ratios and the amounts to be applied over the field generally depend on the agricultural material and on the desirable dose for treating the field (this may be determined by the farm operator).

According to one embodiment of the invention, the agrochemical formulation according to the invention is aqueous.

According to this embodiment, the water content of the agrochemical formulation preferably ranges from 5% to 99% by weight, more preferentially from 20% to 95% by weight, even more preferentially from 25% to 90% by weight, in particular from 25 to 85% by weight, and for instance from 25 to 70% by weight, relative to the total weight of the agrochemical formulation.

According to this embodiment, the pH preferably ranges from 1 to 11, and more preferentially from 2.5 to 9.5.

The pH of the compositions can be adjusted to the desired value by means of basifying agents or acidifying agents. Use may be made, among the basifying agents, of one or more alkaline agents, such as ammonia, sodium hydroxide or ethanolamine. Mention may be made, by way of examples, among the acidifying agents, of inorganic or organic acids, such as hydrochloric acid or orthophosphoric acid.

According to a particular embodiment of the invention, the agrochemical formulation may advantageously comprise:
a) from 0.01% to 90% by weight, preferably from 5% to 60% by weight, of at least one agricultural material, relative to the total weight of the agrochemical formulation,
b) from 5% to 90% by weight, preferably from 10% to 90% by weight, in particular from 30% to 90% by weight, for instance 30% to 80% by weight, of a solvent composition according to the present invention, relative to the total weight of the agrochemical formulation,
c) from 0.1% to 40% by weight, preferably from 1% to 30% by weight, of at least one said co-solvent, relative to the total weight of the agrochemical formulation,
d) from 0.05% to 40% by weight, preferably from 0.1% to 35% by weight, more preferentially from 0.5% to 30% by weight, in particular from 1 to 25% by weight, for instance from 1 to 5% by weight, of at least one surfactant, relative to the total weight of the agrochemical formulation,
e) from 5% to 90% by weight, preferably from 10% to 80% by weight, in particular from 25% to 70% by weight, of water, relative to the total weight of the agrochemical formulation.

Known conventional methods for preparing agrochemical formulations or mixtures of solvents may be implemented. It is possible to undertake this by simply mixing the constituents.

The agrochemical formulation according to the invention may be used to kill or inhibit pests and/or clean and/or inhibit growth of undesired plants.

The agrochemical formulation according to the invention can be diluted and applied to at least one plant, area adjacent to a plant, soil adapted to support growth of a plant, root of a plant, foliage of a plant, and/or seed adapted to produce a plant, in a customary manner; for example by watering (drenching), drip irrigation, spraying, and/or atomizing.

In the above description, all the preferred embodiments with regard to the components may be used individually or in combination.

The examples that follow serve to illustrate the invention.

### EXAMPLES

In the present examples, the term solvent system is a composition and can design either a solvent alone or a blend of several solvents.

The term combo of actives is used to describe an association of several (at least two) different agricultural materials.

### Determination of the Maximal Solubility of an Active or a Combo of Actives in a Solvent System

The maximal solubility of an active or a combo of actives in a solvent system is characterized by visual observation. At a given concentration, if the mixture is limpid (with the naked eye), the active ingredient(s) is (are) considered to be soluble in the solvent system at this concentration. However, if a sedimentation of the active ingredient(s) appears, it is not soluble anymore in the solvent system and the maximal solubility is reached.

The maximal solubility is thus defined as the maximum amount of active ingredient(s) that can be dissolved in the solvent system, equal to the amount at which the mixture remains limpid (with the naked eye).

### Test 1: Maximal Solubility—Description of the Tests for Actives Alone (Solo) in a Solvent System

Each active ingredient or combo is added little by little in different solvent systems. The solutions are magnetically stirred until complete dissolution. Then an additional amount of active ingredient is added and this operation is repeated until the last part of active ingredient added could not be dissolved anymore, taking care to stir the solution after each addition of active ingredient.

### Test 2: Low Temperature Study—Description of the Tests for Combo of Actives

Mixtures are prepared by solubilizing an active or combo of actives at a certain concentration in different solvent systems. Each active is individually weighted and added to the solvent system. Following observations are then carried out:
Visual observation at 25° C.—The appearance of the mixture is noted and the possible presence of crystals is investigated.
Visual observation at 0° C.—The mixture is placed for 7 days at 0° C. and the appearance of the mixture is noted as well as the possible presence of crystals (CIPAC MT39 test).
Visual observation at 0° C. with nucleation—A crystal of each active ingredient is introduced in the solution having spent 7 days at 0° C. to nucleate. The mixture is stirred and placed again for 7 additional days at 0° C. for nucleation. We note the aspect of the mixture and the presence of crystals is eventually identified (CIPAC MT39 test).

A solvent system was considered as a good system if the mixture (solo or combo of actives solvent system) formed a limpid solution (homogeneous liquid phase with the naked eye), while a solvent system is denoted as a bad system if two-phase system, presence of particles, sediments, crystals or turbid solution are obtained.

Test 3: Stability after Dilution (“Emulsification”)

The objective is to evaluate the emulsification stability of emulsion formed by the dispersion of emulsifiable concentrates (EC) in water at a specified dilution rate (for example, 5% as shown below).

First, 95 wt % of water is poured in a 100 mL graduated cylinder. Then, 5 wt % of a mixture of at least one active ingredient dissolved in at least one solvent and at least one surfactant is added in the graduated cylinder.

The cylinder is turned over 10 times in a row in order to emulsify and then let in a 30° C. thermostated bath for hours.

The stability of this emulsion is then assessed in terms of amounts of free ‘oil’ and/or ‘cream’, which separates while the emulsion is allowed to stand undisturbed for 24 hours. Observations are made after 30 minutes, 2 hours and 24 hours.

The ability of the system to re-emulsify at the end of the 24-hour period is also determined by turning over again 10 times in a row the cylinders. Stability is then assessed after 30 minutes and 2 hours after re-emulsification (adapted from CIPAC MT 36.3 test).

### Example 1: Solubilization of Active Ingredients (Solo) in a Binary Solvent System of the Invention

The maximal solubility of picoxystrobin and oxyfluorfen are measured in Rhodiasolv® ADMA 10 (as comparative solvent system) and in blend 1 (solvent system according to the invention, having a RCI of 0.62), according to the protocol described above.

Blend 1 according to the invention consists in 77% by weight of GFbio ReSolv 200 (n-butyl levulinate) and 23% by weight of Rhodiasolv® ADMA 10 (which comprises N,N-dimethyldecanamide), relative to the total weight of the blend.

Values of maximal solubility (in g/100 g of solvent) are summarized in the table below:

| | Fungicides | |
|---|---|---|
| Solvent | Strobilurin | Herbicides |
| system | Picoxystrobin | Oxyfluorfen |
| Rhodiasolv ® ADMA 10 | 30.0 | 49.0 |
| (comparative) | | |
| Blend 1 | 44.1 | 46.9 |
| (invention) | | |

These data show that the solvent system of the invention provides close (for oxyfluorfen) or even very improved (for picoxystrobin) performances in terms of solubilizing performances compared to Rhodiasolv® ADMA 10.

### Example 2: Solubilization of Active Ingredients (Solo) in a Binary Solvent System of the Invention

The following formulation is prepared according to the following protocol:
Formulation A: 50 mg of azoxystrobin are mixed with 950 μL of the solvent system. The solution is then magnetically stirred.

As in example 1, Blend 1 according to the invention consists in 77% by weight of GFbio ReSolv 200 and 23% by weight of Rhodiasolv® ADMA 10, relative to the total weight of the blend.

| | Formulation A |
|---|---|
| | (containing Azoxystrobin) |
| Solvent system | RT |
| Blend 1 | Limpid |

RT: Room Temperature (25° C.)

The formulation A highlights that a solvent system of the invention is able to solubilize azoxystrobin.

Moreover, Blend 1 of the invention advantageously exhibits a high RCI (0.62).

### Example 3: Solubilization of Active Ingredients (Combo) in a Binary Solvent System of the Invention

The following formulation B is also prepared according to the following protocol:
Formulation B: 50 mg of azoxystrobin and 125 mg of prothioconazole are mixed with 825 μL of the solvent system. The solution is then magnetically stirred.

As in example 1, Blend 1 according to the invention consists in 77% by weight of GFbio ReSolv 200 and 23% by weight of Rhodiasolv® ADMA 10, relative to the total weight of the blend.

The characterization is carried out following the method described above.

| | Formulation B |
|---|---|
| | (containing Azoxystrobin/ |
| | Prothioconazole |
| Solvent | 50/125) |
| system | RT |
| Blend 1 | Limpid |

RT: Room Temperature (25° C.)

This formulation highlights that a solvent system of the invention is able to solubilize challenging combo of active ingredients.

### Example 4: Solubilization of Active Ingredients (Solo) in a Solvent System of the Invention Further Containing an Amine Ester Solvent

The maximal solubility of prothioconazole, tebuconazole, picoxystrobin and oxyfluorfen are measured in blend 1 of example 1 and in blend 2, according to the protocol described above.

Blend 2 according to the invention consists in 35% by weight of GFbio ReSolv 200, 32% by weight of Rhodiasolv® ADMA 10 and 33% by weight of Rhodiasolv® Polarclean (which comprises methyl 5-(dimethylamino)-2-methyl-5-oxopentanoate), relative to the total weight of the blend.

Values of maximal solubility (in g/100 g of solvent) are summarized in the table below:

| | Fungicides | | | |
|---|---|---|---|---|
| Solvent | Triazole | | Strobilurin | Herbicides |
| system | Prothioconazole | Tebuconazole | Picoxystrobin | Oxyfluorfen |
| Blend 1 | 47.5 | 31.5 | 44.1 | 46.9 |
| (invention) | | | | |
| Blend 2 | 84.9 | 42.1 | 47.1 | 49.1 |
| (invention) | | | | |

These data show that the solvent systems of the invention yield good performances in terms of solubilizing the active ingredients, and high loadings are achieved.

### Example 5: Solubilization of Active Ingredients (Solo) in a Solvent System of the Invention Further Containing a Cycloalkanone-Based Solvent

The maximal solubility of prothioconazole, tebuconazole, picoxystrobin and oxyfluorfen are measured in blend 1 of example 1 and in blend 3 (having a RCI of 0.80), according to the protocol described above.

Blend 3 according to the invention consists in 33% by weight of GFbio ReSolv 200, 30% by weight of Rhodiasolv® ADMA 10 and 37% by weight of Cyrene® (which comprises dihydrolevoglucosenone), relative to the total weight of the blend.

Values of maximal solubility (in g/100 g of solvent) are summarized in the table below:

| | Fungicides | | | |
|---|---|---|---|---|
| Solvent | Triazole | | Strobilurin | Herbicides |
| system | Prothioconazole | Tebuconazole | Picoxystrobin | Oxyfluorfen |
| Blend 1 | 47.5 | 31.5 | 44.1 | 46.9 |
| (invention) | | | | |
| Blend 3 | 53.3 | 32.7 | 48.8 | 46.9 |
| (invention) | | | | |

These data show that the solvent systems of the invention, blend 1 and blend 3, yield good performances in terms of solubilizing, while further having a high RCI (0.62 and 0.80 respectively).

### Example 6: Solubilization of Active Ingredients (Combo) in a Solvent System of the Invention Further Containing a Cycloalkanone-Based Solvent

6.1 The following formulation is prepared according to the following protocol:
Formulation C: 75 mg of azoxystrobin and 125 mg of prothioconazole are mixed with 800 μL of the solvent system. The solution is then magnetically stirred.

As in example 5, Blend 3 according to the invention consists in 33% by weight of GFbio ReSolv 200, 30% by weight of Rhodiasolv® ADMA 10 and 37% by weight of Cyrene®, relative to the total weight of the blend.

The characterization is carried out following the method described above.

| | Formulation C | | |
|---|---|---|---|
| | (containing Azoxystrobin/ | | |
| | Prothioconazole 75/125) | | |
| Solvent | | 7 days at | 7 days at 0° |
| system | RT | 0° C. | C. + nucleation |
| Blend 3 | Limpid | Limpid | Limpid |

RT: Room Temperature (25° C.)

This formulation highlights that a solvent system of the invention is able to solubilize challenging combo of active ingredients.

The formulation remains stable for 2 weeks at 0° C., even with the additional step of nucleation for the last 7 days.

6.2 The following formulation D is also prepared according to the following protocol:
Formulation D: 75 mg of azoxystrobin and 200 mg of tebuconazole are mixed with 725 μL of the solvent system. The solution is then magnetically stirred.

Blend 4 according to the invention consists in 17% by weight of GFbio ReSolv 200, 46% by weight of Rhodiasolv® ADMA 10 and 37% by weight of Cyrene®, relative to the total weight of the blend.

Blend 4 has a RCI of 0.85.

The characterization is carried out following the method described above.

| | Formulation D | | |
|---|---|---|---|
| | (containing Azoxystrobin/ | | |
| | Tebuconazole 75/200) | | |
| Solvent | | 7 days at | 7 days at 0° |
| system | RT | 0° C. | C. + nucleation |
| Blend 3 | Limpid | Limpid | Limpid |
| Blend 4 | Limpid | Limpid | Limpid |

RT: Room Temperature (25° C.)

This formulation highlights that a solvent system of the invention is able to solubilize challenging combo of active ingredients.

This formulation remains stable for 2 weeks at 0° C., even with the additional step of nucleation for the last 7 days.

### Example 7: Solubilization of Active Ingredients (Solo) in a Binary Solvent System of the Invention

The following formulation E is prepared according to the following protocol:
Formulation E: 50 mg of azoxystrobin are mixed with 950 μL of the solvent system. The solution is then magnetically stirred.

Blend 5 according to the invention consists in 75% by weight of GFbio ReSolv 200 and 25% by weight of Rhodiasolv® ADMA 810 (which comprises N,N-dimethyloctanamide and N,N-dimethyldecanamide), relative to the total weight of the blend.

Blend 6 according to the invention consists in 75% by weight of GFbio ReSolv 200 and 25% by weight of Rhodiasolv® ADMA 10, relative to the total weight of the blend.

| | Formulation E |
|---|---|
| Solvent | (containing Azoxystrobin) |
| system | RT |
| Blend 5 | Limpid |
| (Invention) | |
| Blend 6 | Limpid |
| (Invention) | |

RT: Room Temperature (25° C.)

The formulation E highlights that a solvent system of the invention is able to solubilize azoxystrobin.

Moreover, blends 5 and 6 according to the invention advantageously exhibit a high RCI (respectively 0.62 and 0.63).

### Example 8: Solubilization of Active Ingredients (Combo) in a Binary Solvent System of the Invention

The following formulation F is prepared according to the following protocol:
Formulation F: 50 mg of azoxystrobin and 125 mg of prothioconazole are mixed with 825 μL of the solvent system. The solution is then magnetically stirred.

As in example 7, blend 5 according to the invention consists in 75% by weight of GFbio ReSolv 200 and 25% by weight of Rhodiasolv® ADMA 810 (which comprises N,N-dimethyloctanamide and N,N-dimethyldecanamide), relative to the total weight of the blend.

As in example 7, blend 6 according to the invention consists in 75% by weight of GFbio ReSolv 200 and 25% by weight of Rhodiasolv® ADMA 10, relative to the total weight of the blend.

| | Formulation F |
|---|---|
| | (containing Azoxystrobin/ |
| Solvent | Prothioconazole 50/125) |
| system | RT |
| Blend 5 | Limpid |
| (Invention) | |
| Blend 6 | Limpid |
| (Invention) | |

RT: Room Temperature (25° C.)

The formulation F highlights that a solvent system of the invention is able to solubilize challenging combo of active ingredients.

1. A composition comprising:
(i) at least one first solvent of general formula (A): 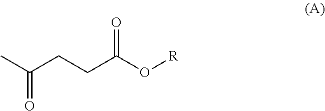
with R representing a linear or branched alkyl group; and
(ii) at least one second solvent of general formula (D): 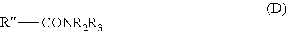
wherein:
R″ is a linear or branched (C₃-C₁₉)alkyl group, and
R₂ and R₃, which are identical or different, denote a hydrogen atom or a (C₁-C₆)alkyl,
with the proviso that if R₂ is a hydrogen atom, then R₃ is a (C₁-C₆)alkyl.

2. The composition according to claim 1, wherein, in formula (A), R represents a linear or branched (C₁-C₆)alkyl group.

3. The composition according to claim 1, wherein, in formula (A), R represents a linear or branched alkyl group containing at least 2 carbon atoms.

4. The composition according to claim 1, wherein, in formula (A), R represents a linear or branched (C₃-C₆)alkyl group.

5. The composition according to claim 1, wherein the total amount of the first solvent ranges from 5% to 95% by weight, relative to the total weight of the composition.

6. The composition according to claim 1, wherein in formula (D):
R″ is a linear or branched (C₇-C₁₉)alkyl group, and/or
R₂ and R₃, which are identical or different, denote a (C₁-C₄)alkyl.

7. The composition according to claim 1, wherein the total amount of the second solvent ranges from 1% to 80% by weight, relative to the total weight of the composition.

8. The composition according to claim 1, wherein the weight ratio of the total content of first solvent(s) to the total content of second solvent(s) ranges from 0.05 to 10.

9. The composition according to claim 1, further comprising one or more additional solvents.

10. The composition according to claim 1, further comprising at least one amide ester solvent of formula (B): 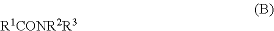
wherein:
R¹ is a linear or branched, saturated aliphatic group, having from 1 to 6 carbon atoms, substituted by one or more functional groups chosen from —OH groups and/or —COOR′ groups, wherein R′ is a (C₁-C₆)alkyl group,
R² and R³, which are identical or different, are a (C₁-C₆)alkyl group, R¹ and R² or R³ optionally together form a ring, the ring containing 4 to 6 carbon atoms and optionally substituted by one or more (C₁-C₄)alkyl groups and/or one or more functional groups chosen from —OH groups, —OR′ groups, —COOR′ groups and —CONR⁴R⁵ groups, wherein R′ is a (C₁-C₆)alkyl group and R⁴ and R⁵, which are identical or different, denote a (C₁-C₆)alkyl group.

11. The composition according to claim 1, further comprising at least one dioxolane-based solvent of formula (C) below: 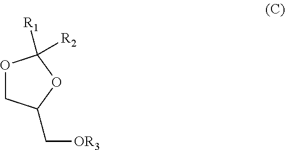
wherein,
R₁ and R₂, independent from one another, are a linear or branched C₁-C₁₂ alkyl, a C₄-C₁₂ cycloalkyl or an aryl,
R₃ is H, a linear or branched (C₁-C₆)alkyl, a (C₃-C₈)cycloalkyl, or a —C(O)R₄ group, with R₄ being a linear or branched C₁-C₄ alkyl or C₅-C₆ cycloalkyl.

12. The composition according to claim 1, further comprising at least one solvent chosen from levoglucosenone, dihydrolevoglucosenone or a derivative thereof.

13. A method for preparing an agrochemical formulation, the method comprising preparing the composition as defined in claim 1.

14. A method for preparing a solvent, the method comprising preparing a solvent as defined in claim 1.

15. An agrochemical formulation comprising:
a) at least one agricultural material,
b) a composition as defined in claim 1,
c) optionally at least one emulsifier, and
d) optionally water.

16. The formulation according to claim 15, wherein the agrochemical formulation is in the form of an emulsifiable concentrate, an emulsion in water concentrate, a microemulsion concentrate, a suspoemulsion concentrate, an oil dispersion concentrate or a dispersible concentrate.

17. The formulation according to claim 15, wherein the composition b) represents from 10% to 99% by weight, relative to the total weight of the agrochemical formulation.

18. The composition according to claim 1, wherein, in formula (A), R represents a linear or branched (C₂-C₆)alkyl group.

19. The composition according to claim 1, wherein, in formula (A), R represents a linear or branched alkyl group containing at least 3 carbon atoms.

20. The composition according to claim 1, wherein, in formula (A), R represents a linear or branched alkyl group containing at least 4 carbon atoms.
